(19) United States
(12) Patent Application Publication
(10) Pub. No.: US 2026/0135323 A1
(43) Pub. Date: May 14, 2026

(54) Multi-Piece Electrical Connector

(71) Applicants: Tarng Yu Enterprise co., ltd., New Taipei City (TW); Dongguan Tarng Yu Electronics Co., Ltd., Dongguan City (CN)

(72) Inventors: YING-CHUNG CHEN, New Taipei City (TW); MU-JUNG HUANG, New Taipei City (TW)

(21) Appl. No.: 19/388,028

(22) Filed: Nov. 13, 2025

(30) Foreign Application Priority Data
Nov. 13, 2024 (TW) 113212412

(51) Int. Cl. H01R 13/502; H01R 13/62

(52) U.S. Cl. CPC H01R 13/502; H01R 13/62

(57) ABSTRACT

A multi-piece electrical connector, which is configured to be disposed in an electronic device for signal transmission, wherein the multi-piece electrical connector is formed by combining multiple electrical connector sub-components. Therefore, after the design of the multi-piece electrical connector is completed, customized adjustment of the mating structure and the number of conductive terminals of the electrical connector can still be achieved by adjusting the combination of the multiple electrical connector sub-components. As a result, the multi-piece electrical connector can be adapted for various types of electronic devices.

### CROSS-REFERENCE TO RELATED APPLICATIONS

This application claims the priority of Republic of China Patent Application No. 113212412 filed on November 13, 2024, in the State Intellectual Property Office of the R.O.C., the disclosure of which is incorporated herein by reference.

### BACKGROUND OF THE INVENTION

### FIELD OF THE INVENTION

The present application relates to the technical field of electronic devices, and more particularly, to a multi-piece electrical connector for allowing its coupling port features and the number of its conductive terminals to be customized.

### Descriptions of the Related Art

In various modern electronic devices, there are usually provided electrical connectors that can be couple with the electronic devices to transmit signals. In response to specific requirements and developments of those electronic devices, it is preferable that the coupling port features and the number of conductive terminals of the electrical connectors can be customized to meet diverse signal transmission demands. However, currently once an electrical connector has been designed, its coupling structure and the number of its conductive terminals are fixed and cannot be adjusted, thereby rendering such an electrical connector unsuitable for a variety of electronic devices.

In view of the foregoing, how to customize the coupling port features and the number of conductive terminals of an electrical connector has become a critical technical challenge that the current industry is striving to overcome.

### SUMMARY OF THE INVENTION

In view of the drawbacks of the prior art mentioned above, the present application provides a multi-piece electrical connector comprising: a major electrical connector subcomponent comprising a major insulation core and a major conductive terminal, the major insulation core comprising a major core combination space and a major core coupling port, the major core coupling port comprising a major core coupling port terminal insertion space and a major core coupling port feature, wherein the major conductive terminal is inserted into the major core coupling port and enters the major core coupling port terminal insertion space; and a minor electrical connector subcomponent comprising a minor insulation core, the minor insulation core comprising a minor core combination body, a minor core coupling port, and a minor core terminal positioning structure, the minor core coupling port comprising a minor core coupling port feature; wherein the minor electrical connector subcomponent is configured to combine with the major electrical connector subcomponent, such that the minor core combination body is inserted into the major core combination space, allowing the minor core terminal positioning structure to position the major conductive terminal to prevent the major conductive terminal from being detached from the major core coupling port terminal insertion space, and allowing the minor core coupling port to be detached from the major core combination space and exposed outside, such that the minor core coupling port and the major core coupling port are cooperated for coupling, and the major core coupling port feature and the minor core coupling port feature are substantially identical or substantially different.

Preferably, the multi-piece electrical connector said above, wherein the major insulation core further comprises a major core terminal positioning structure configured to position the major conductive terminal to prevent the major conductive terminal from being detached from the major core coupling port terminal insertion space.

Preferably, the multi-piece electrical connector said above, wherein the major core terminal positioning structure is an elastic abutting structure configured to elastically abut the major conductive terminal.

Preferably, the multi-piece electrical connector said above, wherein the minor core terminal positioning structure is an abutting structure configured to abut the major conductive terminal.

Preferably, the multi-piece electrical connector said above, wherein the minor insulation core further comprises a minor core mating structure being mated with the major insulation core to maintain the combination relationship between the minor electrical connector subcomponent and the major electrical connector subcomponent.

Preferably, the multi-piece electrical connector said above, wherein the minor core combination body comprises two sides which are respectively a minor core combination body coupling side and a minor core combination body positioning side, wherein the minor core coupling port is located at the minor core combination body coupling side, and the minor core terminal positioning structure is located at the minor core combination body positioning side.

Preferably, the multi-piece electrical connector said above, wherein the minor core coupling port comprises a hollow cylindrical structure comprising a minor core coupling port terminal insertion space, and the minor electrical connector subcomponent further comprises a minor conductive terminal, the minor conductive terminal being inserted into the minor core coupling port and enters the minor core coupling port terminal insertion space.

Preferably, the multi-piece electrical connector said above, wherein the major conductive terminal and the minor conductive terminal are signal terminals or power terminals.

Preferably, the multi-piece electrical connector said above configured to be cooperated with a major conductive cable to form a cable-end connector, wherein the minor insulation core further comprises a minor core cable passage structure configured to guide the major conductive cable into the major insulation core to be electrically connected with the major conductive terminal, wherein the minor core cable passage structure is separated from the minor core terminal positioning structure.

Preferably, the multi-piece electrical connector said above, wherein the major core coupling port feature and the minor core coupling port feature are color features or structural features.

Preferably, the multi-piece electrical connector said above, wherein the minor core coupling port comprises a minor core coupling port foolproof structure configured to provide coupling foolproof functionality.

Preferably, the multi-piece electrical connector said above, wherein the minor core coupling port foolproof structure is a chamfer structure.

Compared to the prior art, the multi-piece electrical connector provided by the present application, which is configured to be disposed in an electronic device for signal transmission, wherein the multi-piece electrical connector is formed by combining multiple electrical connector sub-components. Therefore, after the design of the multi-piece electrical connector is completed, customized adjustment of the mating structure and the number of conductive terminals of the electrical connector can still be achieved by adjusting the combination of the multiple electrical connector sub-components. As a result, the multi-piece electrical connector can be adapted for various types of electronic devices.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a perspective schematic view of the multi-piece electrical connector of the present application according to one embodiment.

FIG. 2 is a perspective schematic view of the multi-piece electrical connector of the present application according to one embodiment.

FIG. 3 is a perspective schematic view of the multi-piece electrical connector of the present application from a first viewing angle according to one embodiment.

FIG. 4 is a perspective schematic view of the multi-piece electrical connector of the present application from a second viewing angle according to one embodiment.

FIG. 5 is a perspective schematic view of the multi-piece electrical connector of the present application from a third viewing angle according to one embodiment.

FIG. 6 is a perspective schematic view of the multi-piece electrical connector of the present application from a first viewing angle according to one embodiment.

FIG. 7 is a perspective schematic view of the multi-piece electrical connector of the present application from a second viewing angle according to one embodiment.

FIG. 8 is a perspective schematic view of the multi-piece electrical connector of the present application from a third viewing angle according to one embodiment.

FIG. 9 is a front schematic view of the multi-piece electrical connector of the present application according to one embodiment.

FIG. 10 is a sectional schematic view of a portion of the multi-piece electrical connector shown in FIG. 9, taken along line AA.

FIG. 11 is a sectional schematic view of a portion of the multi-piece electrical connector shown in FIG. 9, taken along line A’A’.

FIG. 12 is a sectional schematic view of a portion of the multi-piece electrical connector shown in FIG. 9, taken along line BB.

### DETAILED DESCRIPTION OF THE PREFERRED EMBODIMENT

Embodiments of the present invention will now be described in detail with reference to the accompanying drawings. The invention may, however, be embodied in many different forms and should not be construed as being limited to the embodiments set forth herein. Rather, these embodiments are provided such that this disclosure will be thorough and complete, and will fully convey the scope of the invention to those skilled in the art.

The present application provides at least one multi-piece electrical connector. The multi-piece electrical connector is configurable to be installed in an electronic device to couple with a coupling component for signal transmission. Optionally, the multi-piece electrical connector may couple with the coupling component inside the electronic device; however, it is not limited thereto, and the multi-piece electrical connector may also couple with the coupling component outside the electronic device. The multi-piece electrical connector is formed by assembling multiple electrical connector subcomponents. Therefore, even after the multi-piece electrical connector is designed, the coupling structure and the number of conductive terminals of the electrical connector can still be custom-adjusted by modifying the assembled subcomponents, thereby enabling the multi-piece electrical connector to be applicable to various electronic devices.

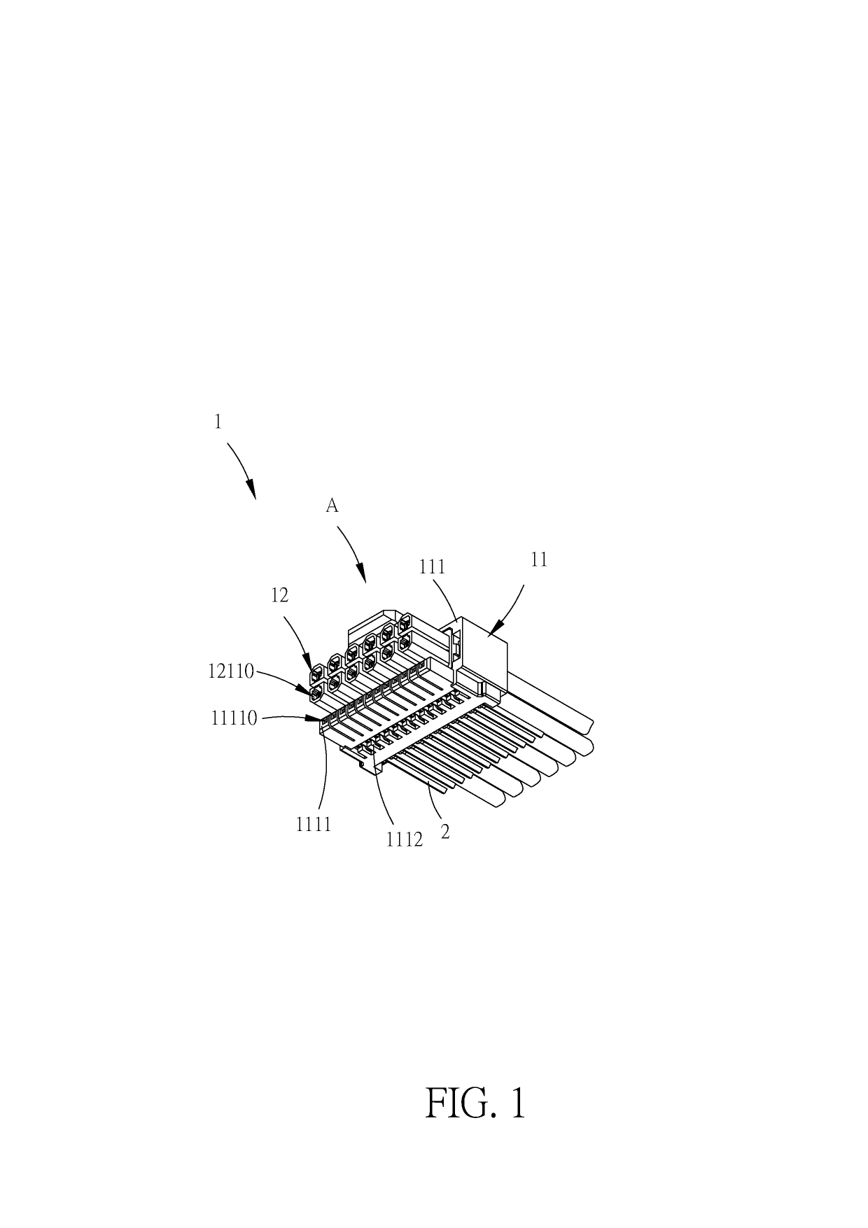

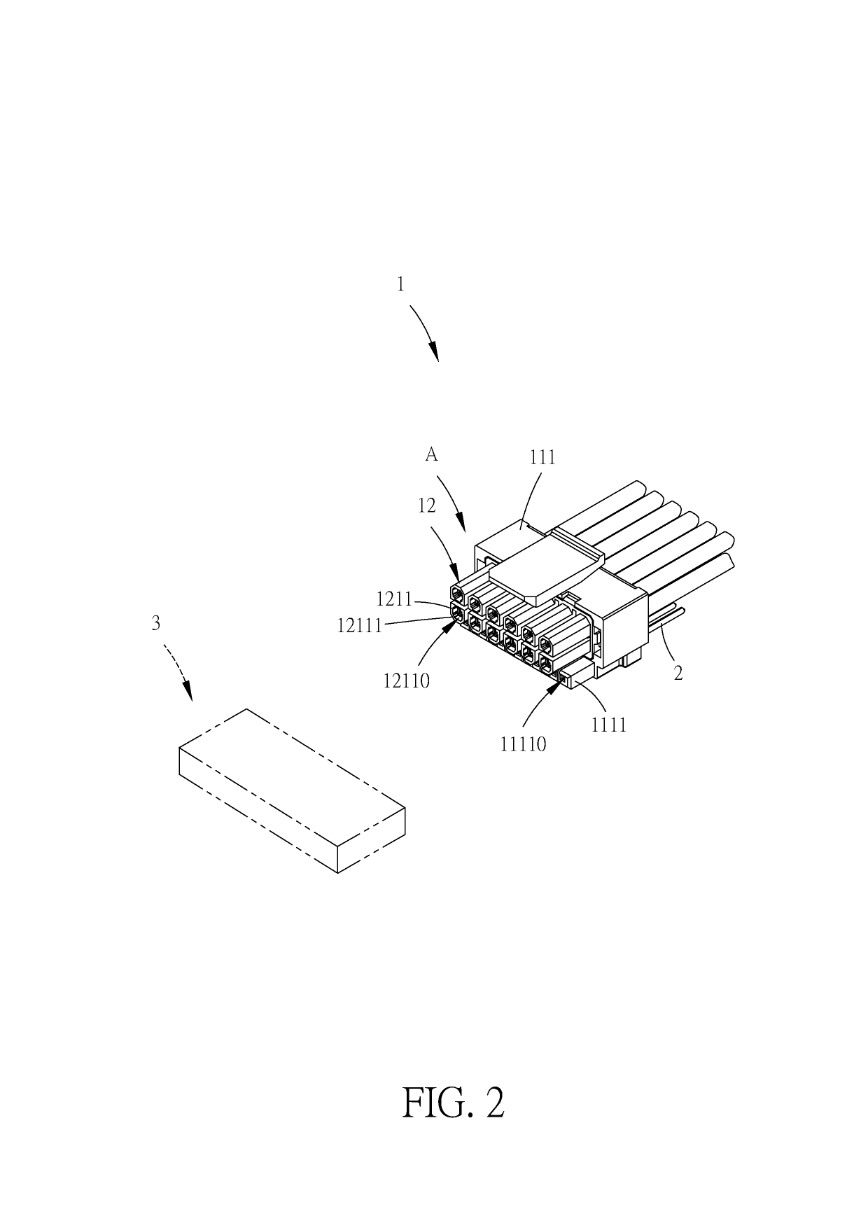

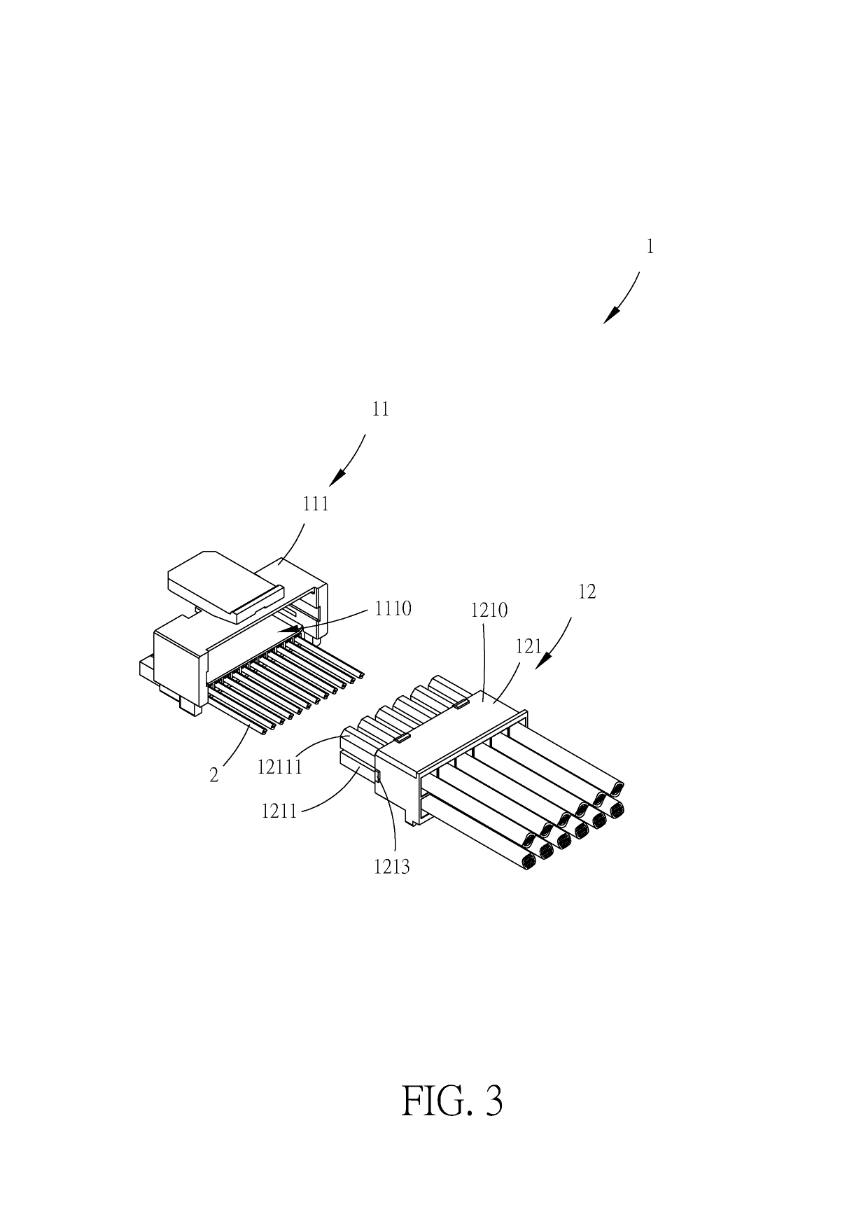

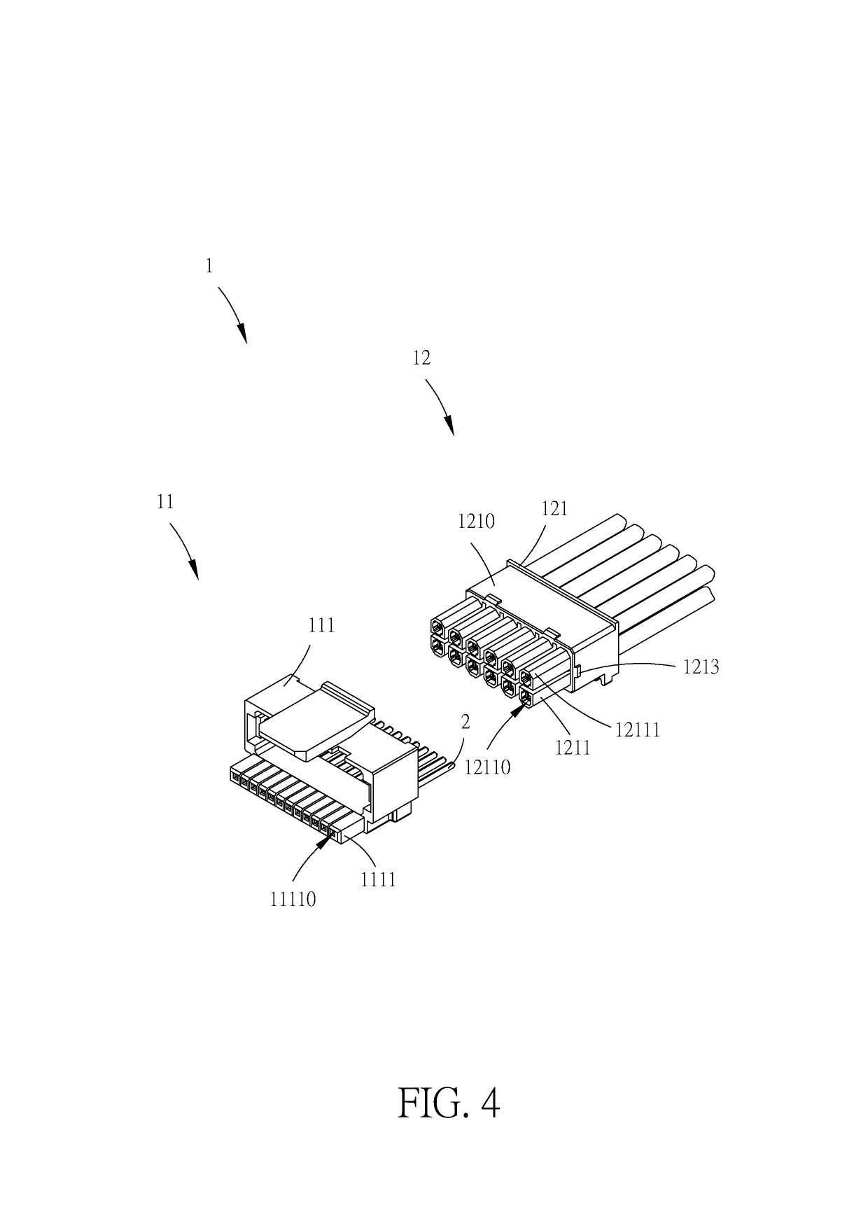

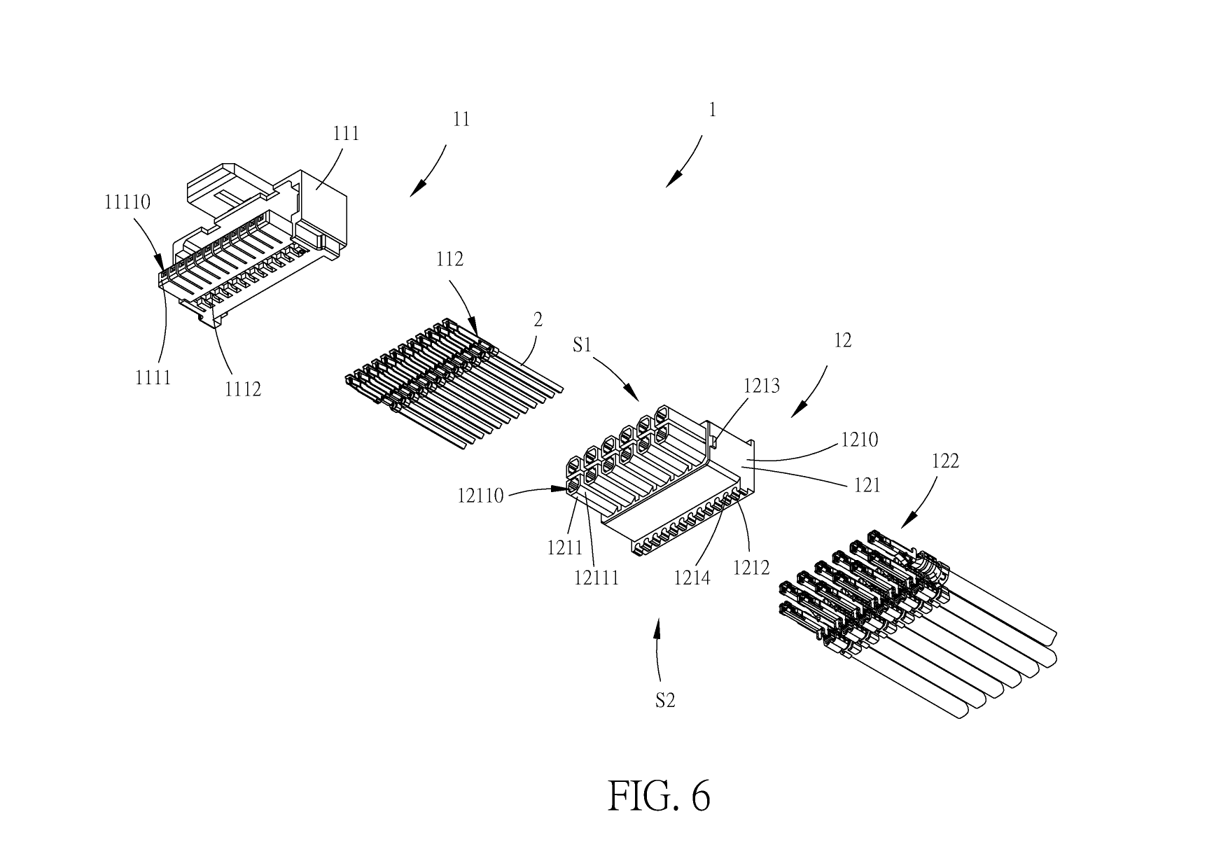

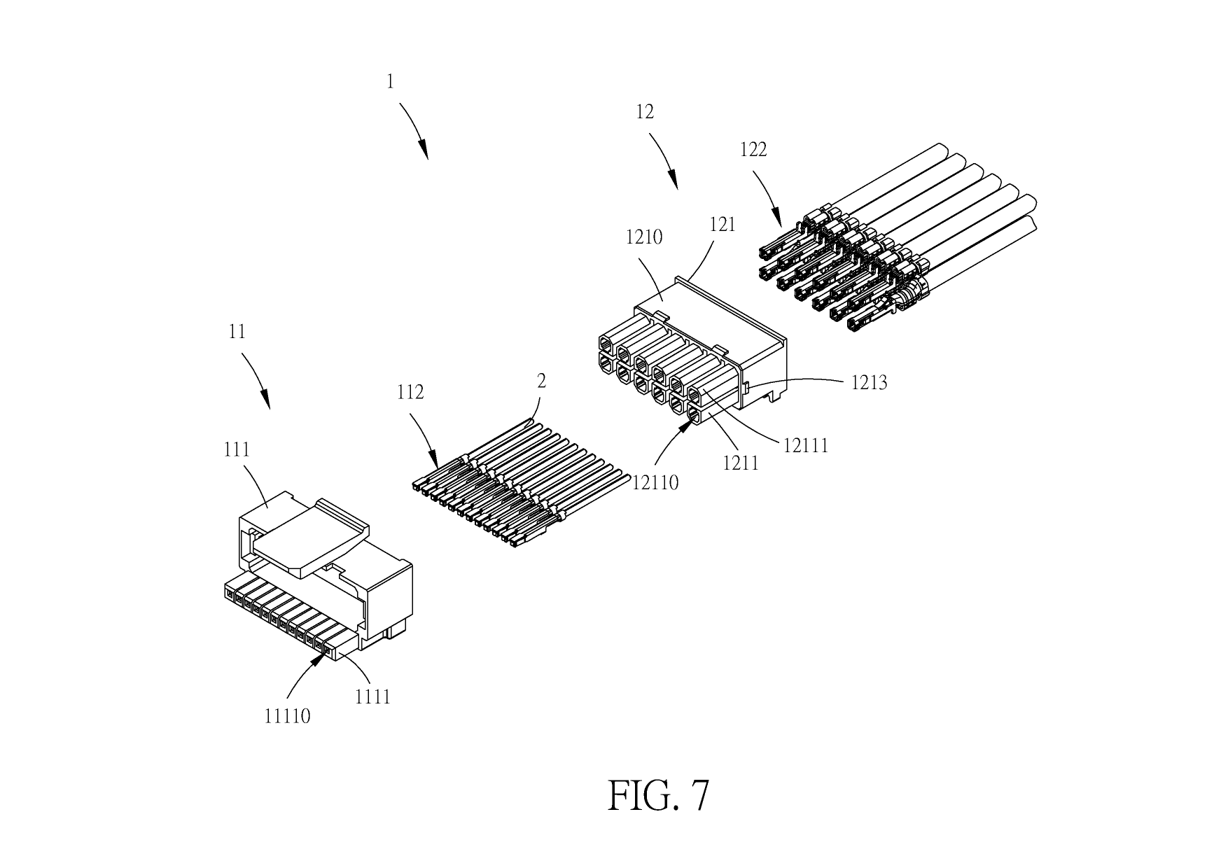

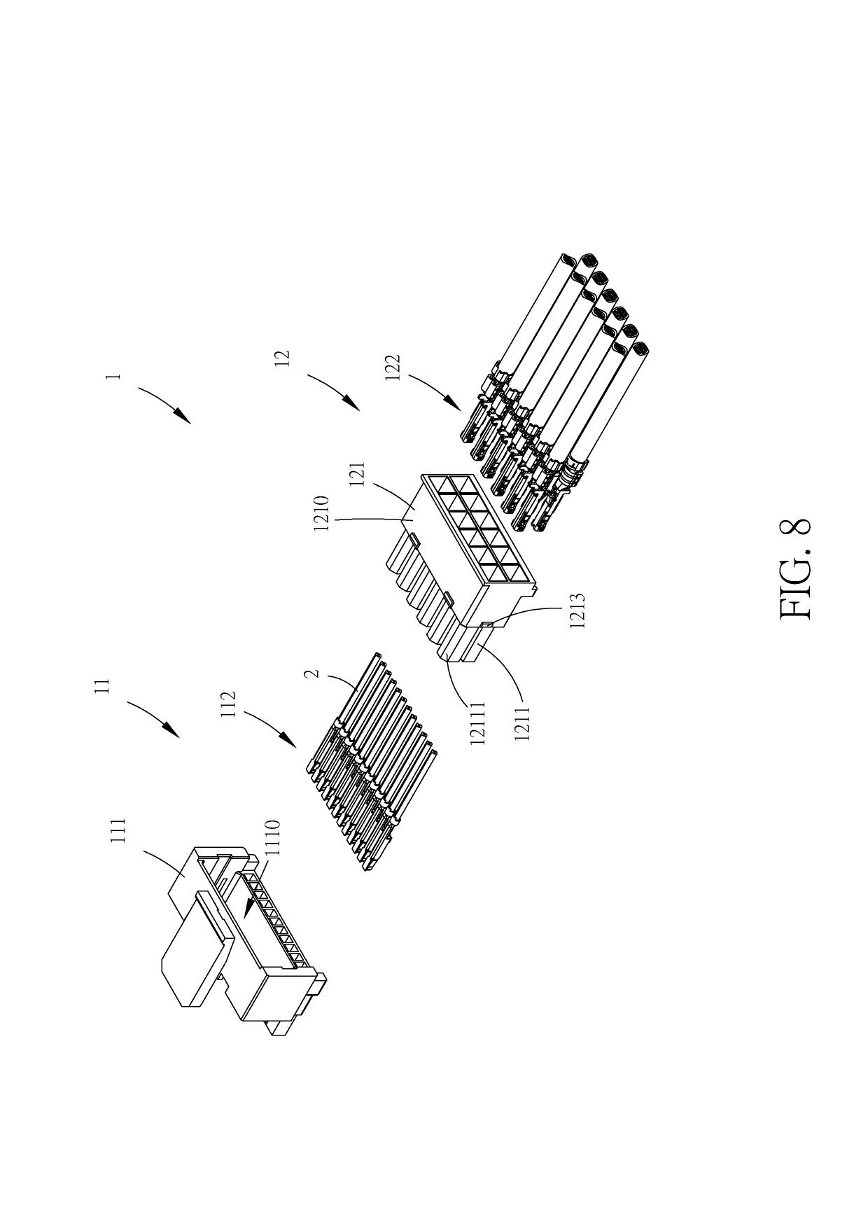

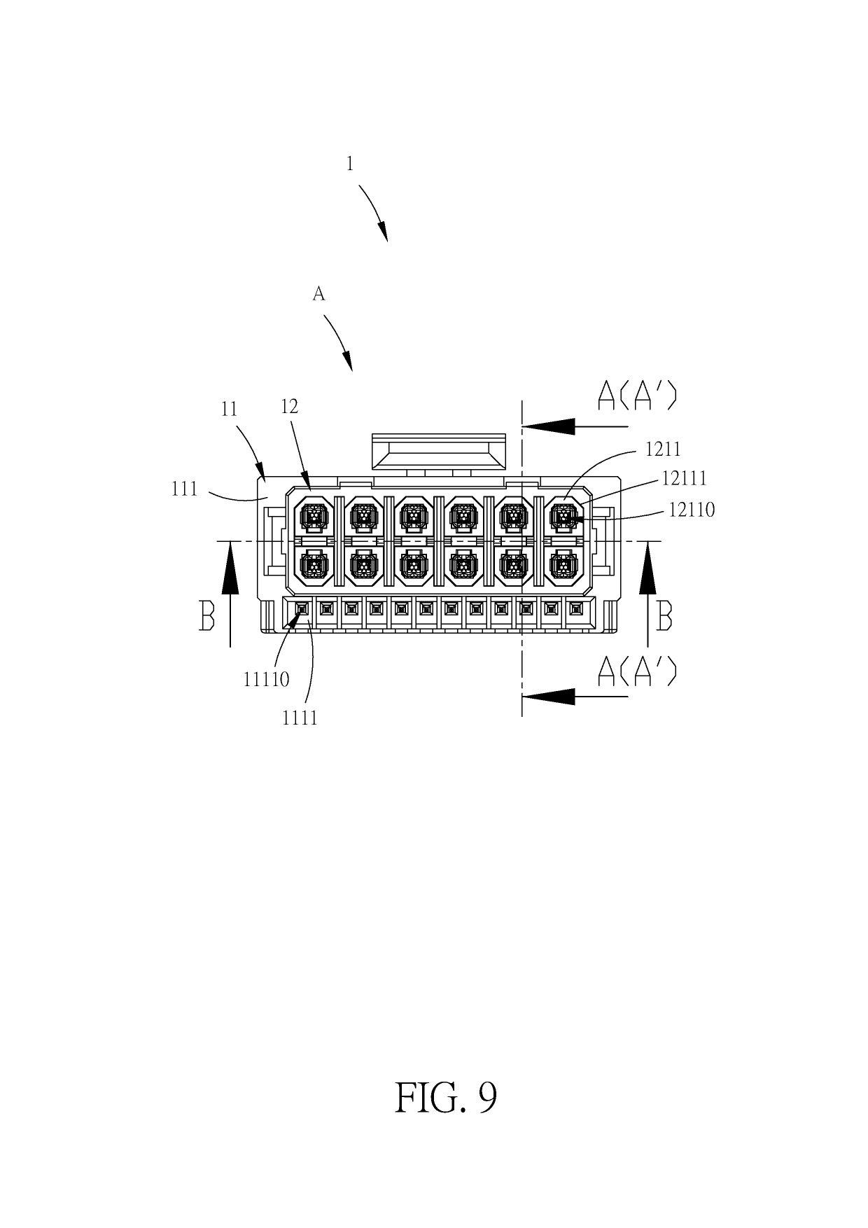

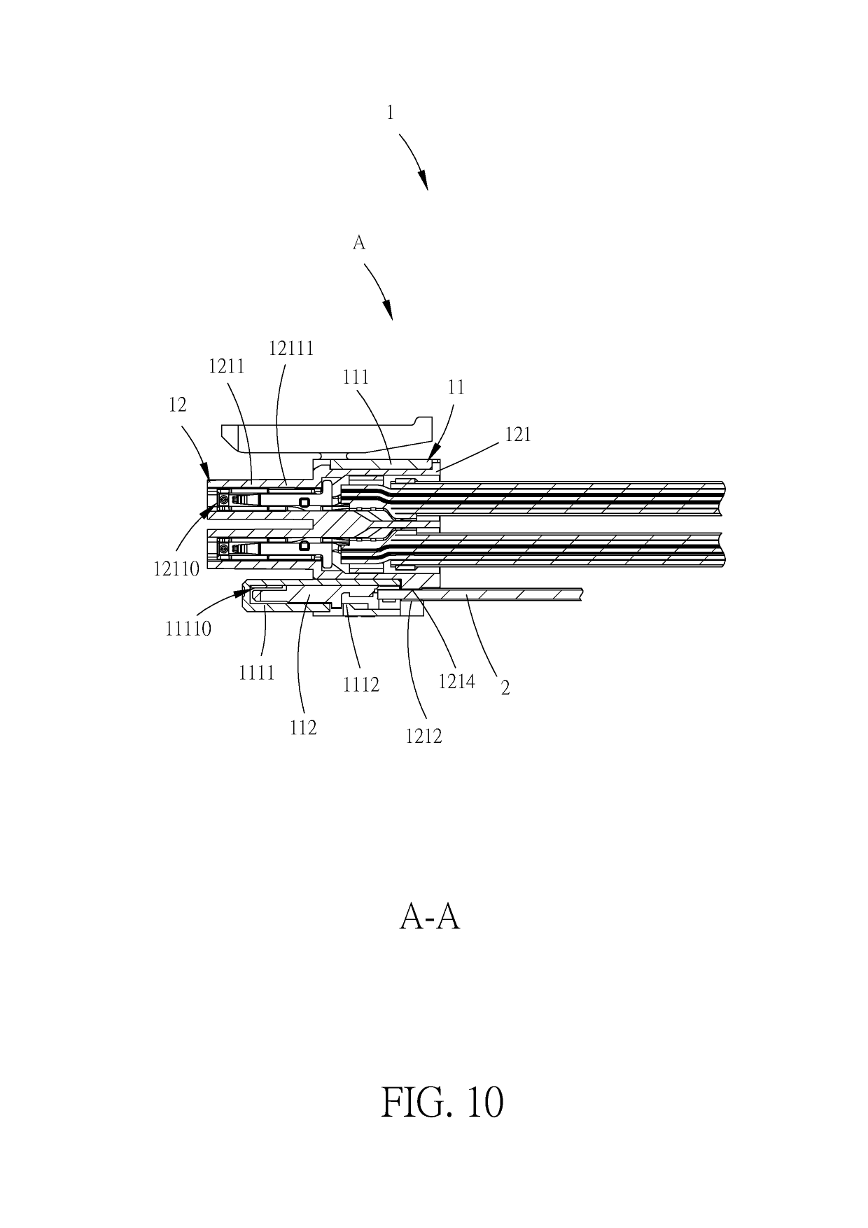

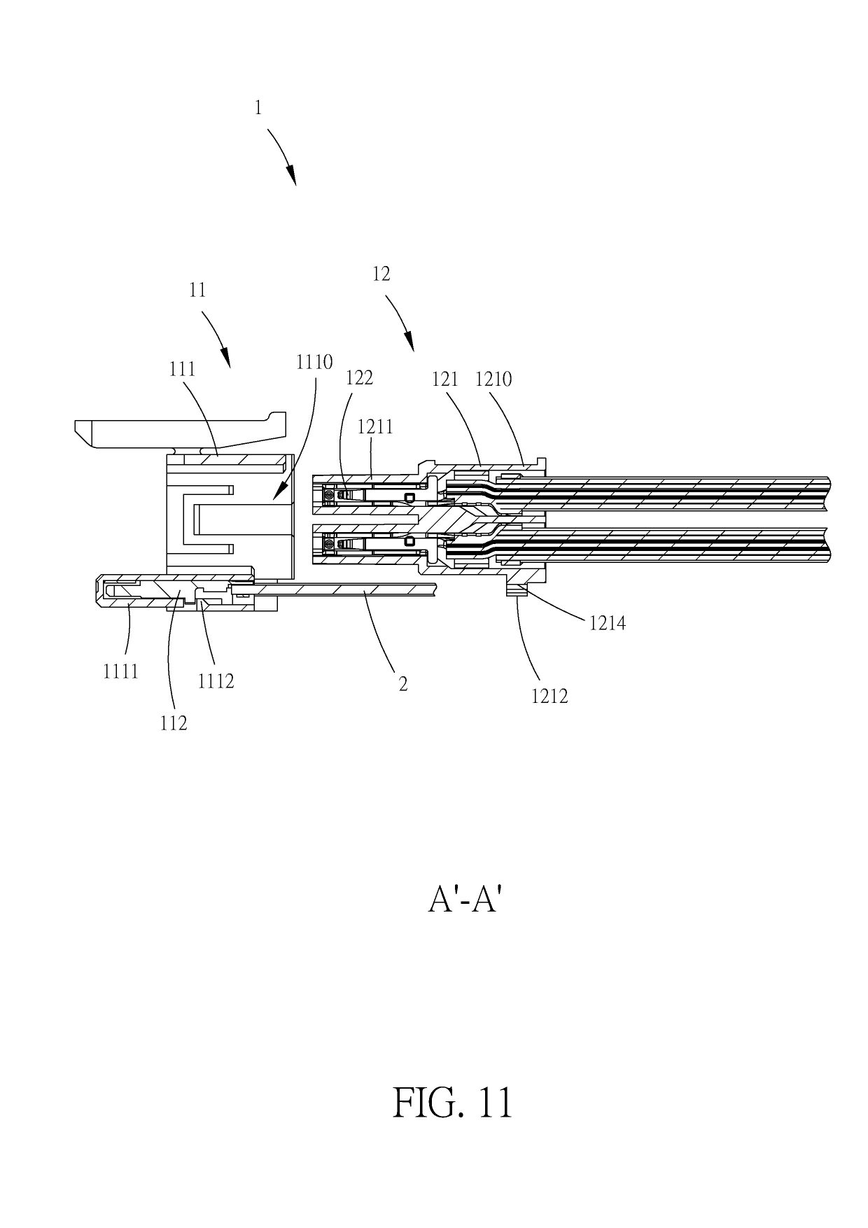

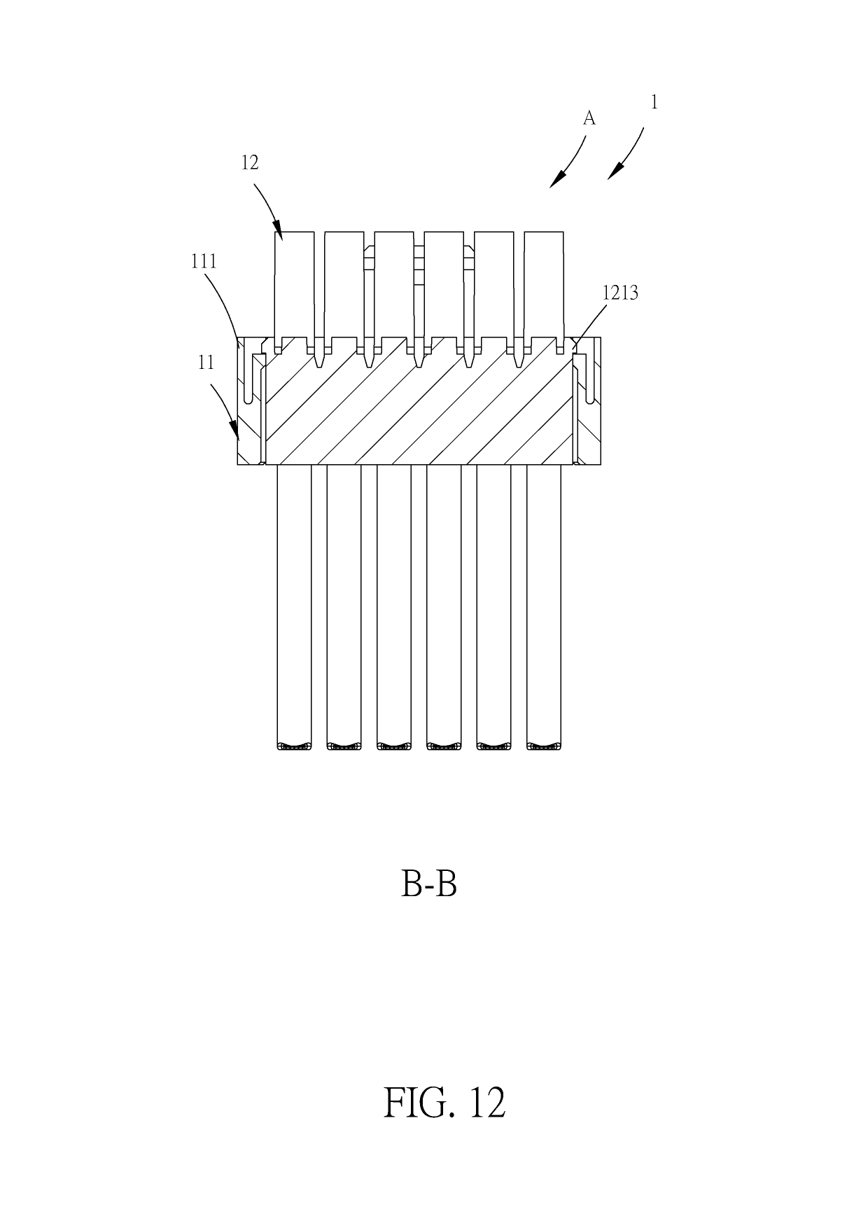

For a detailed description of the embodiments disclosed in the present application, please refer to FIGS. 1 to 12.

In the embodiments shown in FIGS. 1 to 12, a multi-piece electrical connector 1 is provided. The multi-piece electrical connector is configured to mate with a coupling component 3 for signal transmission. The multi-piece electrical connector 1 comprises: at least one major electrical connector subcomponent 11 and at least one minor electrical connector subcomponent 12. It should be noted that the coupling component 3 may, but is not limited to, be a mating connector.

Regarding the major electrical connector subcomponent 11, it comprises at least one major insulation core 111 and at least one major conductive terminal 112. The major insulation core 111 has a major core combination space 1110 and a major core coupling port 1111. The major core coupling port 1111 includes a major core coupling port terminal insertion space 11110 and a major core coupling port feature. The major core coupling port terminal insertion space 11110 extends through the major core coupling port 1111. Accordingly, the major conductive terminal 112 is inserted through the major core coupling port 1111 into the major core coupling port terminal insertion space 11110 to couple with the coupling component 3.

It should be noted that the major core coupling port feature may be selected as a color feature to identify the major core coupling port 1111 during mating with the coupling component 3, thereby determining whether the major core coupling port 1111 has been properly coupled. However, the feature is not limited thereto and may instead be a structural feature, allowing the major core coupling port 1111 to adapt to the structure of the coupling component 3 to facilitate successful mating. Furthermore, the number of the major conductive terminals 112 may be custom-adjusted, and the major conductive terminals 112 may be signal terminals or power terminals to satisfy signal transmission requirements of various electronic devices.

In the embodiments shown in FIGS. 1, 5 to 6, and 10 to 11, the major insulation core 111 further comprises a major core terminal positioning structure 1112. The major core terminal positioning structure 1112 may, but is not limited to, be an elastic abutting structure configured to elastically abut the major conductive terminal 112. In this way, the major core terminal positioning structure 1112 can position the major conductive terminal 112 to prevent it from being detached from the major core coupling port terminal insertion space 11110.

Regarding the minor electrical connector subcomponent 12, it comprises at least one minor insulation core 121 and at least one minor conductive terminal 122. The minor insulation core 121 is configured to pair with the major electrical connector subcomponent 11 and comprises a minor core combination body 1210, at least one minor core coupling port 1211, and at least one minor core terminal positioning structure 1212. Two sides of the minor core combination body 1210 are defined respectively as a minor core combination body coupling side S1 and a minor core combination body positioning side S2. The minor core coupling port 1211 is located at the minor core combination body coupling side S1 and includes a minor core coupling port feature. The minor core coupling port 1211 is a hollow cylindrical structure comprising a minor core coupling port terminal insertion space 12110, which extends through the minor core coupling port 1211. Accordingly, the minor conductive terminal 122 is inserted through the minor core coupling port 1211 into the minor core coupling port terminal insertion space 12110 to couple with the coupling component 3. The minor core terminal positioning structure 1212 is located at the minor core combination body positioning side S2 to position the major conductive terminal 112 inserted into the major core coupling port terminal insertion space 11110, thereby preventing the major conductive terminal 112 from being detached.

It should be noted that the minor core coupling port feature may be selected as a color feature to identify the minor core coupling port 1211 during mating with the coupling component 3, thereby determining whether mating has been properly achieved. However, the feature is not limited thereto and may instead be a structural feature, allowing the minor core coupling port 1211 to adapt to the structure of the coupling component 3 to facilitate successful mating. Furthermore, the number of the minor conductive terminals 122 may be custom-adjusted, and the minor conductive terminals 122 may be signal terminals or power terminals to satisfy signal transmission requirements of various electronic devices.

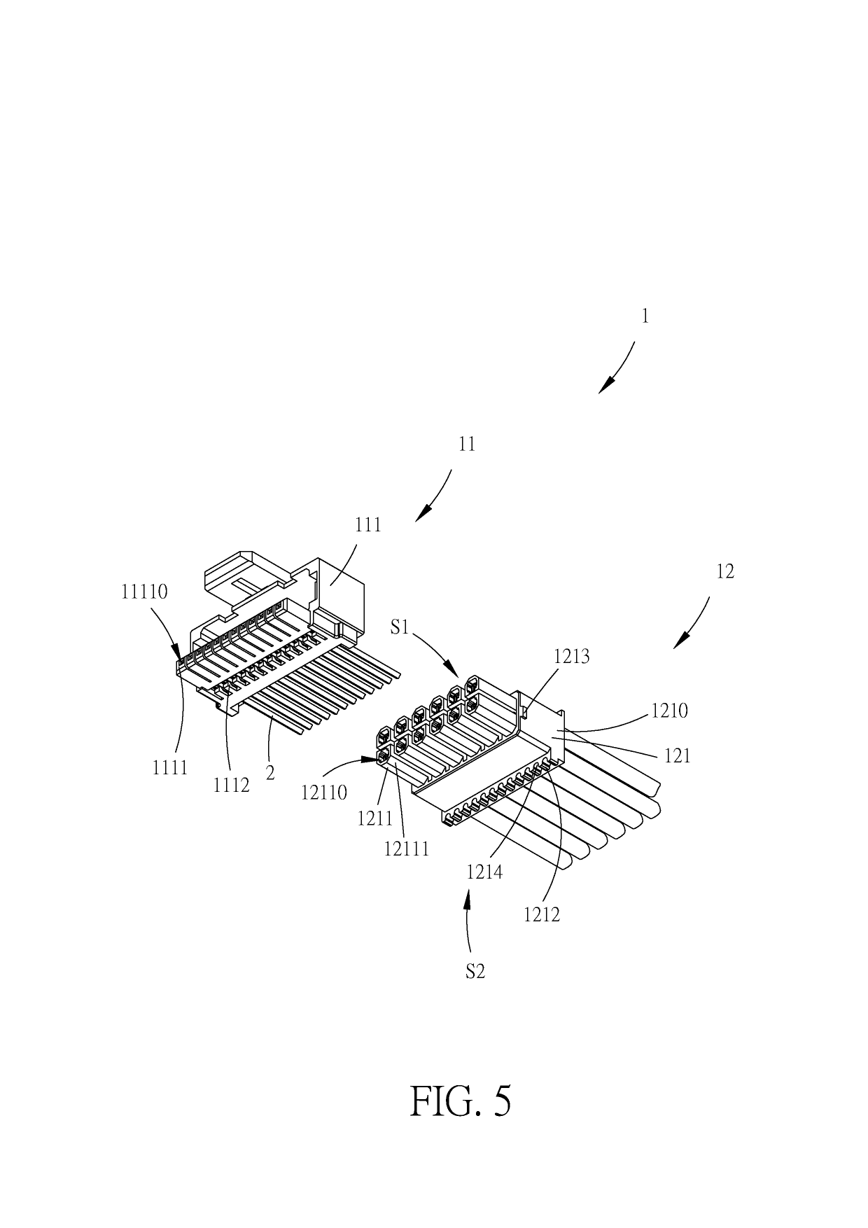

In the embodiments shown in FIGS. 5 to 6 and 10 to 11, the minor core terminal positioning structure 1212 may, but is not limited to, be an abutting structure configured to abut the major conductive terminal 112.

In the embodiments shown in FIGS. 5 to 6 and 10 to 11, the multi-piece electrical connector 1 may be combined with a major conductive cable 2 to form a cable-end connector. It should be noted that the minor insulation core 121 further comprises a minor core cable passage structure 1214, which is configured to guide the major conductive cable 2 into the major insulation core 111 to electrically connect with the major conductive terminal 112. The minor core cable passage structure 1214 is disposed to avoid the minor core terminal positioning structure 1212 to prevent interference with the major conductive cable 2 entering the major insulation core 111.

In the above embodiment, the minor electrical connector subcomponent 12 is combinable with the major electrical connector subcomponent 11, such that the minor core combination body 1210 is inserted into the major core combination space 1110. The minor core terminal positioning structure 1212 can position the major conductive terminal 112 at the minor core combination body positioning side S2 to prevent it from being detached from the major core coupling port terminal insertion space 11110, thereby extending the service life of the multi-piece electrical connector 1. Furthermore, after the minor core combination body 1210 enters the major core combination space 1110, the minor core coupling port 1211 protrudes from the major core combination space 1110 to be exposed, so that the minor core coupling port 1211 and the major core coupling port 1111 are coupled form an electrical connector core coupling port assembly A for mating with the coupling component 3. In the present embodiment, the major core coupling port feature and the minor core coupling port feature may be substantially identical or substantially different to allow the electrical connector core coupling port assembly A to adapt to the coupling component 3 and facilitate successful mating.

In the above embodiment, the minor insulation core 121 further comprises a minor core mating structure 1213, which may, but is not limited to, be a latch structure, fastening structure, or interference structure. In this way, the minor core mating structure 1213 is mated with the major insulation core 111 to prevent the minor insulation core 121 from being detached, thereby maintaining the assembled relationship between the minor electrical connector subcomponent 12 and the major electrical connector subcomponent 11, such that the two subcomponents are integrally combined.

Furthermore, the minor core coupling port 1211 comprises a minor core coupling port foolproof structure 12111, which may, but is not limited to, be a chamfer structure. In this way, the minor core coupling port foolproof structure 12111 may provide foolproof functionality for the coupling between the minor core coupling port 1211 (or the electrical connector core coupling port assembly A) and the coupling component 3.

Moreover, the minor core combination body 1210 and the major core combination space 1110 may be formed in a complementary protrusion-recess structure to reduce the combined dimensions of the minor and major electrical connector subcomponents 12 and 11, thereby reducing the overall size of the multi-piece electrical connector 1 and facilitating the development of electronic devices toward a thinner, lighter, and more compact form factor.

It should be noted that in the above embodiment, certain components may be omitted. For example, the present application provides a multi-piece electrical connector comprising a major electrical connector subcomponent and a minor electrical connector subcomponent. The major electrical connector subcomponent comprises a major insulation core and a major conductive terminal. The major insulation core comprises a major core combination space and a major core coupling port. The major core coupling port comprises a major core coupling port terminal insertion space and a major core coupling port feature. The major conductive terminal is inserted through the major core coupling port into the major core coupling port terminal insertion space. The minor electrical connector subcomponent comprises a minor insulation core. The minor insulation core comprises a minor core combination body, a minor core coupling port, and a minor core terminal positioning structure. The minor core coupling port comprises a minor core coupling port feature. Wherein, the minor electrical connector subcomponent is combinable with the major electrical connector subcomponent such that the minor core combination body is inserted into the major core combination space, enabling the minor core terminal positioning structure to position the major conductive terminal to prevent it from being detached from the major core coupling port terminal insertion space, and the minor core coupling port to protrude from the major core combination space to be exposed, thereby allowing the minor core coupling port and the major core coupling port to be cooperated for providing coupling functionality, and the major core coupling port feature and minor core coupling port feature to be substantially identical or substantially different.

In summary, the present application provides a multi-piece electrical connector that is installable in an electronic device for signal transmission. The multi-piece electrical connector is formed by assembling multiple electrical connector subcomponents, wherein the coupling port features and the number of conductive terminals of the subcomponents may be substantially different. Therefore, even after the design of the multi-piece electrical connector is completed, the coupling structure and the number of conductive terminals of the electrical connector can still be custom-adjusted by changing the combination of subcomponents, allowing the multi-piece electrical connector to be applicable to various electronic devices to meet the specific needs and developments of such devices.

The examples above are only illustrative to explain principles and effects of the invention, but not to limit the invention. It will be apparent to those skilled in the art that modifications and variations is enable to be made without departing from the spirit and scope of the invention. Therefore, the protection range of the rights of the invention should be as defined by the appended claims.

What is claimed is:

1. A multi-piece electrical connector comprising:
a major electrical connector subcomponent comprising a major insulation core and a major conductive terminal, the major insulation core comprising a major core combination space and a major core coupling port, the major core coupling port comprising a major core coupling port terminal insertion space and a major core coupling port feature, wherein the major conductive terminal is inserted into the major core coupling port and enters the major core coupling port terminal insertion space; and
a minor electrical connector subcomponent comprising a minor insulation core, the minor insulation core comprising a minor core combination body, a minor core coupling port, and a minor core terminal positioning structure, the minor core coupling port comprising a minor core coupling port feature; wherein
the minor electrical connector subcomponent is configured to combine with the major electrical connector subcomponent, such that the minor core combination body is inserted into the major core combination space, allowing the minor core terminal positioning structure to position the major conductive terminal to prevent the major conductive terminal from being detached from the major core coupling port terminal insertion space, and allowing the minor core coupling port to be detached from the major core combination space and exposed outside, such that the minor core coupling port and the major core coupling port are cooperated for coupling, and the major core coupling port feature and the minor core coupling port feature are substantially identical or substantially different.

2. The multi-piece electrical connector of claim 1, wherein the major insulation core further comprises a major core terminal positioning structure configured to position the major conductive terminal to prevent the major conductive terminal from being detached from the major core coupling port terminal insertion space.

3. The multi-piece electrical connector of claim 2, wherein the major core terminal positioning structure is an elastic abutting structure configured to elastically abut the major conductive terminal.

4. The multi-piece electrical connector of claim 1, wherein the minor core terminal positioning structure is an abutting structure configured to abut the major conductive terminal.

5. The multi-piece electrical connector of claim 1, wherein the minor insulation core further comprises a minor core mating structure being mated with the major insulation core to maintain the combination relationship between the minor electrical connector subcomponent and the major electrical connector subcomponent.

6. The multi-piece electrical connector of claim 1, wherein the minor core combination body comprises two sides which are respectively a minor core combination body coupling side and a minor core combination body positioning side, wherein the minor core coupling port is located at the minor core combination body coupling side, and the minor core terminal positioning structure is located at the minor core combination body positioning side.

7. The multi-piece electrical connector of claim 1, wherein the minor core coupling port comprises a hollow cylindrical structure comprising a minor core coupling port terminal insertion space, and the minor electrical connector subcomponent further comprises a minor conductive terminal, the minor conductive terminal being inserted into the minor core coupling port and enters the minor core coupling port terminal insertion space.

8. The multi-piece electrical connector of claim 7, wherein the major conductive terminal and the minor conductive terminal are signal terminals or power terminals.

9. The multi-piece electrical connector of claim 1 configured to be cooperated with a major conductive cable to form a cable-end connector, wherein the minor insulation core further comprises a minor core cable passage structure configured to guide the major conductive cable into the major insulation core to be electrically connected with the major conductive terminal, wherein the minor core cable passage structure is separated from the minor core terminal positioning structure.

10. The multi-piece electrical connector of claim 1, wherein the major core coupling port feature and the minor core coupling port feature are color features or structural features.

11. The multi-piece electrical connector of claim 1, wherein the minor core coupling port comprises a minor core coupling port foolproof structure configured to provide coupling foolproof functionality.

12. The multi-piece electrical connector of claim 11, wherein the minor core coupling port foolproof structure is a chamfer structure.
